(19) United States
(12) Patent Application Publication
(10) Pub. No.: US 2008/0250467 A1
(43) Pub. Date: Oct. 9, 2008

(54) METHOD OF PROCESSING BROADCASTING SERVICE INFORMATION AND HYBRID TV USING THE SAME

(75) Inventor: Zhang-hoon OH, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/971,435

(22) Filed: Jan. 9, 2008

(30) Foreign Application Priority Data
Apr. 9, 2007 (KR) 10-2007-0034622

(51) Int. Cl. H04N 7/173

(52) U.S. Cl. 725/114

(57) ABSTRACT

A method of processing broadcasting service information and a hybrid TV using the same are provided. The hybrid TV receives SD&S information by determining whether broadcasting service information on whether one or more broadcasting providers concurrently provide IPTV broadcasting services in one-to-one correspondence with legacy broadcasting services, which are substitutable for each other, is included in a packet received from an IP network and discarding the received packet, when it is determined that broadcasting service information is not included in the received packet.

### CROSS-REFERENCE TO RELATED PATENT APPLICATION

This application claims priority from Korean Patent Application No. 10-2007-0034622, filed on Apr. 9, 2007, in the Korean Intellectual Property Office, the disclosure of which is incorporated herein in its entirety by reference.

### BACKGROUND OF THE INVENTION

1. Field of the Invention

The present invention relates to processing broadcasting service information and more particularly, to a method of processing broadcasting service information for reducing memory consumption and a hybrid TV using the same.

2. Description of the Related Art

A television (TV) serves to receive a predetermined broadcasting signal and display the received predetermined broadcasting signal as received. A set-top box (STB) serves to receive an external signal and display the external signal on a TV connected to the STB. Since an Internet Protocol television (IPTV) and an Internet Protocol (IP) STB serve to receive a broadcasting program through an internet protocol, hereinafter, the IP STB and the IPTV are referred to as IPTVs.

An STB which serves to receive only broadcasting programs using an IP among IP STBs is referred to as a pure IPTV STB. In the hybrid TV, a function of the pure IPTV STB and a function of a legacy broadcasting STB are combined. Namely, a user can watch contents streamed through a broadcasting network or broadband network by using the aforementioned hybrid TV. The hybrid TV may be also referred to as a hybrid IPTV.

FIG. 1 illustrates a structure of a related art hybrid TV.

The hybrid TV includes a pure IP STB and a cable STB. The hybrid TV may further include a ground wave STB and a satellite STB in addition to the cable STB. Hereinafter, the hybrid TV obtained by combining the cable STB with the pure IP STB will be described.

A mode in which an IPTV STB sub-system employed by the pure IP STB operates is referred to as an IPTV mode. A mode in which a legacy STB sub-system employed by a legacy broadcasting STB operates is referred to as a legacy mode.

The hybrid TV separately receives IPTV packets and cable TV signals respectively through an IPTV packet receiver and a cable signal receiver. The hybrid TV provides pictures to a user by processing an IPTV media streaming packet among the received IPTV packets or by processing cable signals. At this time, in the legacy mode, only legacy broadcasting programs which are received by the legacy STB sub-system can be tuned and watched. In the IPTV mode, only IPTV streaming broadcasting programs which are received by the IPTV STB sub-system can be watched. The hybrid TV enables the user to change modes from the legacy mode to the IPTV mode. However, since the IPTV STB sub-system has to operate while the legacy STB sub-system operates, the IPTV STB sub-system has to receive and process all the updated packets of the broadcasting service information and service discovery and selection (SD&S) information.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of processing broadcasting service information for reducing memory consumption and a hybrid TV using the same in which IPTV and legacy modes can be used at the same time.

According to an aspect of the present invention, there is provided a method of processing broadcasting service information, the method comprising: determining if broadcasting service information on whether one or more broadcasting providers concurrently provide IPTV broadcasting services in one-to-one correspondence with legacy broadcasting services, which are substitutable for each other, is included in a packet received from an IP network; and discarding the received packet, when it is determined that broadcasting service information is not included in the received packet.

According to another aspect of the present invention, there is provided a hybrid TV comprising: a control unit which determines if broadcasting service information on whether one or more broadcasting providers concurrently provide IPTV broadcasting services in one-to-one correspondence with legacy broadcasting services, which are substitutable for each other, is included in a packet received from an IP network and outputs a control signal for instructing the received packet to be discarded, when it is determined that broadcasting service information is not included in the received packet; and a receiving unit which receives the control signal output from the control unit and discards the received packet.

According to another aspect of the present invention, there is provided a computer-readable recording medium having embodied thereon a computer program for executing a method of processing broadcasting service information, the method comprising: determining if broadcasting service information on whether one or more broadcasting providers concurrently provide IPTV broadcasting services in one-to-one correspondence with legacy broadcasting services, which are substitutable for each other, is included in a packet received from an IP network; and discarding the received packet, when it is determined that broadcasting service information is not included in the received packet.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a structure of a related art hybrid TV;

FIG. 2 is a block diagram illustrating a hybrid TV according to an exemplary embodiment of the present invention;

FIG. 3 is a flowchart illustrating a method of processing broadcasting service information in a hybrid TV according to an exemplary embodiment of the present invention;

FIG. 4 is a flowchart illustrating a method of automatically storing channel information in a hybrid TV according to an exemplary embodiment of the present invention;

FIG. 5 is a flowchart illustrating a method of selecting a channel in a hybrid TV according to an exemplary embodiment of the present invention;

FIG. 6 is a table illustrating a channel table used by a hybrid TV according to an exemplary embodiment of the present invention;

FIG. 7A illustrates a related art Digital Video Broadcasting Service Discovery & Selection Transport Protocol DVBSTP (SD&S multicast delivery protocol);

FIG. 7B illustrates a modified DVBSTP (SD&S multicast delivery protocol) according to an exemplary embodiment of the present invention;

FIG. 8A illustrates an extensible markup language (XML) schema in which a modified DVBSTP includes broadcasting service information; and

FIG. 8B illustrates a part in which an XML schema including broadcasting information is declared.

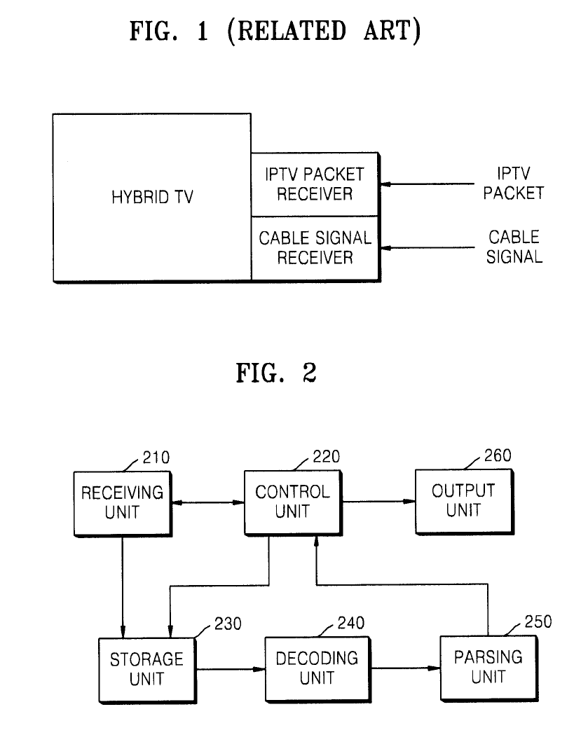

### DETAILED DESCRIPTION OF EXEMPLARY EMBODIMENTS OF THE INVENTION

Hereinafter, the present invention will be described in detail by explaining exemplary embodiments of the invention with reference to the attached drawings.

Digital Video Broadcasting (DVB) is an international standard for digital TVs. A DVB service discovery & selection transport protocol (DVBSTP) is a protocol defined in the standard of DVB for distinguishing a plurality of service providers and services from one another.

FIG. 2 is a block diagram illustrating a hybrid TV according to an exemplary embodiment of the present invention.

Referring to FIG. 2, the hybrid TV according to the exemplary embodiment is constructed with a receiving unit 210, a control unit 220, a storage unit 230, a decoding unit 240, a parsing unit 250, and an output unit 260.

The receiving unit 210 receives a DVBSTP packet through an IP network. The DVBSTP packet is designed to use a protocol defined in the DVB standard for distinguishing a plurality of service providers and services from one another.

When the receiving unit 210 receives the DVBSTP packet, the control unit 220 determines whether the hybrid TV is in a legacy mode or in an IPTV mode and examines a bit x included in the DVBSTP packet. The bit x is added to a header of the DVBSTP packet by one or more SD&S service providers. The bit x represents whether a segment in which the DVBSTP packet exists includes information on whether one or more broadcasting providers concurrently provide IPTV broadcasting services in one-to-one correspondence with legacy broadcasting services, which are substitutable for each other. When the bit x is 1, the bit x represents that the segment in which the DVBSTP packet exists includes the information on whether one or more broadcasting providers concurrently provide IPTV broadcasting services in one-to-one correspondence with the legacy broadcasting services, which are substitutable for each other. When the bit x is 0, the bit x represents that the segment in which the DVBSTP packet exists does not include the information on whether one or more broadcasting providers concurrently provide IPTV broadcasting services in one-to-one correspondence with the legacy broadcasting services, which are substitutable for each other. In the legacy mode, broadcasting services are provided through an existing means such as a cable, a ground wave, a satellite, and the like. In the IPTV mode, broadcasting services are provided through internet protocols (IPs).

If it is determined that the hybrid TV is in the legacy mode and if the bit x is 0, the DVBSTP packet received by the receiving unit 210 is not processed and ignored. If it is determined that the hybrid TV is in the IPTV mode or the legacy mode and if the bit x is 1, a control signal for instructing the DVBSTP packet received by the receiving unit 210 to be stored in the storage unit 230 is output. When receiving an XML parsing result from the parsing unit 250, the control unit 220 determines from the XML parsing result whether the channel information provided by the broadcasting provider is changed. If the channel information is changed, the channel information stored in the storage device (not shown) is updated. The updating of the channel information in the storage device (not shown) is performed through EEPROM programming. The channel information includes broadcasting service information. The broadcasting service information represents whether one or more broadcasting providers concurrently provide IPTV broadcasting services in one-to-one correspondence with the legacy broadcasting services, which are substitutable for each other. If an obsoleteness flag for representing the broadcasting service information is 1, the obsoleteness flag represents that one or more broadcasting providers concurrently provide IPTV broadcasting services in one-to-one correspondence with the legacy broadcasting services, which are substitutable for each other. If the obsoleteness flag is 0, the obsoleteness flag represents that one or more broadcasting providers provide only legacy broadcasting signals.

A user setting information includes information for representing that the user determines to watch an IPTV broadcasting program between IPTV and legacy broadcasting programs. When an allow-IPTV flag for representing the user setting information is 1, the allow-IPTV flag represents that the user determines to watch an IPTV broadcasting program. When the allow-IPTV flag for representing the user setting information is 0, the allow-IPTV flag represents that the user determines to watch a legacy broadcasting program.

The control unit 220 examines a channel table constructed with the channel information stored in the storage device (not shown). As a result of the examination of the channel table, if the obsoleteness flag for representing the broadcasting service information is 0, or if the obsoleteness flag for representing the broadcasting service information is 1 and the allow-IPTV flag for representing user setting information is 0, the control unit 220 transmits a control signal for instructing a legacy broadcasting program to be output to the output unit 260. If the obsoleteness flag for representing the broadcasting service information is 1 and if the allow-IPTV flag for representing the user setting information is 1, the control unit 220 transmits a control signal for instructing an IPTV broadcasting program to be output to the output unit 260.

The storage unit 230 receives the control signal of the control unit 220, stores the DVBSTP packet received by the receiving unit 210, and outputs the DVBSTP packet to the decoding unit 240.

The decoding unit 240 receives the DVBSTP packet from the storage unit 230, decodes the DVBSTP packet, and outputs the decoded DVBSTP packet to the parsing unit 250. When decoding the DVBSTP packet, the binary format for multimedia description streams (BiM) decoding may be used. The BiM decoding is defined as a method of encoding descriptions in the MPEG-7 system standard.

When receiving the decoded DVBSTP packet from the decoding unit 240, the parsing unit 250 performs XML parsing and outputs the XML parsing result to the control unit 220.

The output unit 260 receives a control signal from the control unit 220 and outputs a legacy or IPTV broadcasting program based on the received control signal.

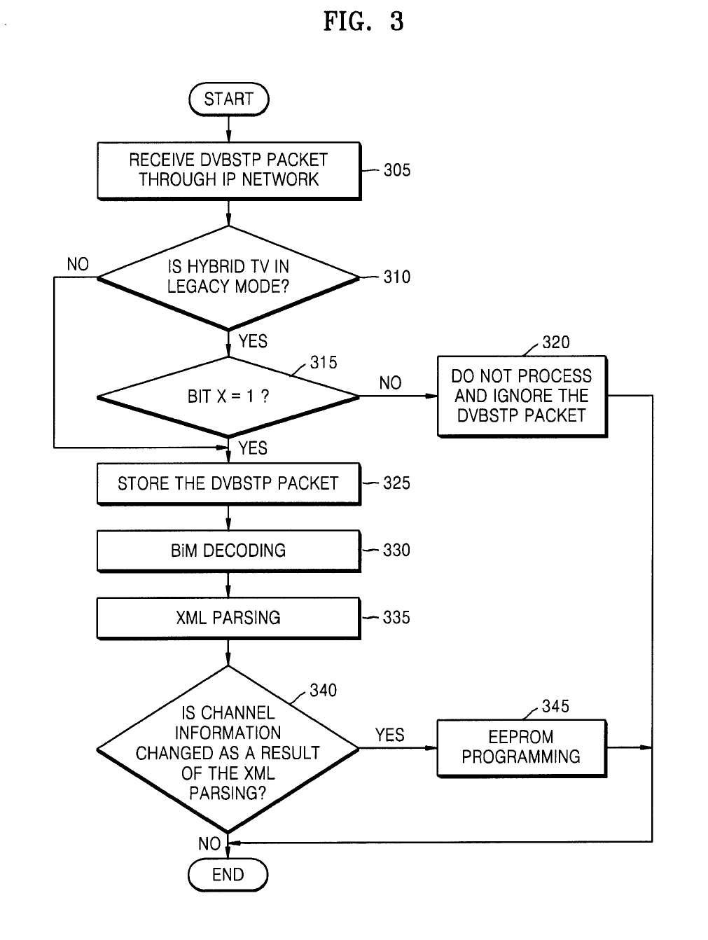

FIG. 3 is a flowchart illustrating a method of processing broadcasting service information in a hybrid TV according to an exemplary embodiment of the present invention.

Referring to FIG. 3, the method of processing the broadcasting service information according to the exemplary embodiment of the present invention includes a sequence of operations of the hybrid TV shown in FIG. 2. Accordingly, the description on the hybrid TV shown in FIG. 2 is also applied to the method of processing the broadcasting service information according to the exemplary embodiment.

In operation 305, the hybrid TV receives the DVBSTP packet through the IP network.

In operation 310, it is determined whether the hybrid TV operates in the IPTV or legacy mode. When the hybrid TV operates in the IPTV mode, it proceeds to operation 325. When the hybrid TV operates in the legacy mode, it proceeds to operation 315.

In operation 315, the hybrid TV examines the DVBSTP received in operation 305 and determines whether the DVBSTP includes the broadcasting service information (obsoleteness flag) from a bit x that constitutes the DVBSTP packet.

If the bit x is 1, the bit x represents that the broadcasting service information is included in the DVBSTP packet. If the bit x is 0, the bit x represents that the broadcasting service information is not included in the DVBSTP packet.

In operation 320, the hybrid TV does not process the received DVBSTP packet and ignores the received DVBSTP packet, when it is determined in operation 315 that the broadcasting service information is not included in the received DVBSTP packet.

In operation 325, the hybrid TV stores the DVBSTP packet received in operation 305 in the storage unit 230, if it is determined in operation 315 that the broadcasting service information is included in the DVBSTP packet or if it is determined in operation 310 that the hybrid TV operates in the IPTV mode. When the hybrid TV operates in the IPTV mode, the two cases are either the bit x is 1 or the bit x is 0. When the hybrid TV operates in the IPTV mode and when the broadcasting service information is included in the DVBSTP packet (the bit x is 1), the DVBSTP packet may be stored in an R1 memory area. When the hybrid TV operates in the IPTV mode and when the broadcasting service information is not included in the DVBSTP packet (the bit x is 0), the DVBSTP packet may be stored in an R2 memory area. It is possible to more rapidly access the R1 memory area than any other memory area. The R2 memory area is used to decode and parse the updated DVBSTP packet. The R2 memory area has a slower access speed than the R1 memory area. For example, an embedded memory belongs to the R1 memory area. An external memory belongs to the R2 memory area.

In operation 330, when the DVBSTP packet received in operation 305 is encoded, the hybrid TV performs decoding of the encoded DVBSTP packet. The decoding may be the BiM decoding.

In operation 335, the hybrid TV performs the XML parsing of the DVBSTP decoded in operation 330. Service discovery & selection (SD&S) information may be multicast-transmitted by using the DVBSTP packet. At this time the SD&S information may be generated as an XML document. The SD&S information is used to search and select broadcasting information provided by a plurality of broadcasting providers. The SD&S information is provided at an IP level.

The SD&S information is used for the following two procedures. At first, the SD&S information is used for a searching procedure. The broadcasting information provided by the plurality of broadcasting providers is provided at the IP level. A list of broadcasting services is suggested to the user. And the user is allowed to access the broadcasting services. At second, the SD&S information is used for a selection procedure. When the user determines to watch a desired broadcasting service, the user selects the desired broadcasting service. Contents of the existing SD&S information is defined in the ETSI 102 034 v1.2.1 standard.

In case of multicast transmission, the SD&S information can be transmitted to terminals through the DVBSTP. In case of unicast transmission, the SD&S information can be transmitted to terminals through HTTP. The SD&S information is transmitted in an XML record form. An existing schema on the XML record is defined in the ETSI 102 034 v1.2.1 standard. In operation 335, an XML record is created by gathering and processing DVBSTP packets. As the XML parsing result of the XML record, the SD&S information can be obtained.

In operation 340, the hybrid TV determines from the SD&S information obtained by performing the XML parsing in operation 335 whether the broadcasting service provided by the broadcasting service provider is changed. When the broadcasting service is not changed, the aforementioned procedure is performed for the next packet.

In operation 345, the hybrid TV determines from the SD&S information obtained by performing the XML parsing in operation 335 whether the broadcasting service provided by the broadcasting service provider is changed. When the broadcasting service is changed, the SD&S information stored in the storage device is updated. The broadcasting service information (obsoleteness flag) of the storage device in which the channel information is stored is also updated. The latter updating can be performed through the EEPROM programming.

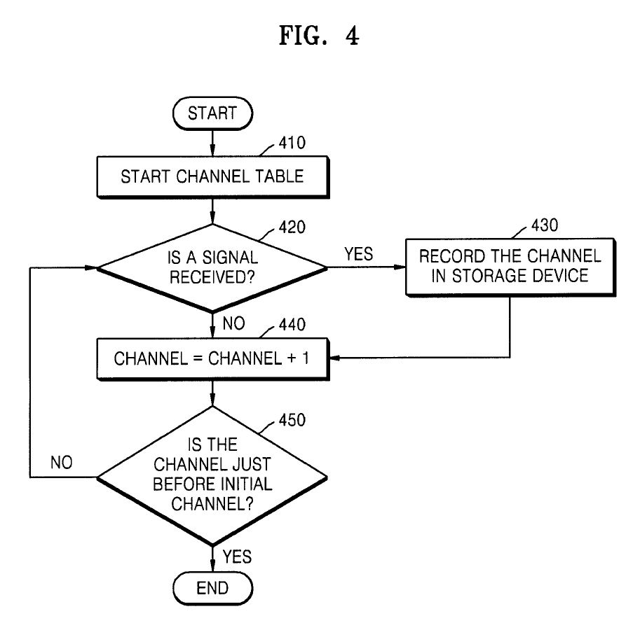

FIG. 4 is a flowchart illustrating a method of automatically storing channel information in a hybrid TV according to an exemplary embodiment of the present invention.

In operation 410, the hybrid TV sequentially selects channels in the channel table.

In operation 420, the hybrid TV checks whether the broadcasting signal is received from the channel selected in operation 410.

In operation 430, when the broadcasting signal is received from the selected channel as the result of checking in operation 420, the hybrid TV records information on the selected channel in the storage device. The channel information may include the broadcasting service information (obsoleteness flag) and the user setting information (allow-IPTV flag).

In operation 440, when the broadcasting signal is not received as the result of checking in operation 420, or when the information on the selected channel is stored in the storage device in operation 430, the hybrid TV selects the next channel of the selected channel.

In operation 450, the hybrid TV determines whether the currently selected channel is a just previous channel of an initially selected channel. As the result of determination, when the currently selected channel is the just previous channel of the initially selected channel, the method is terminated. As the result of determination, when the currently selected channel is not the just previous channel of the initially selected channel, the method proceeds to operation 420.

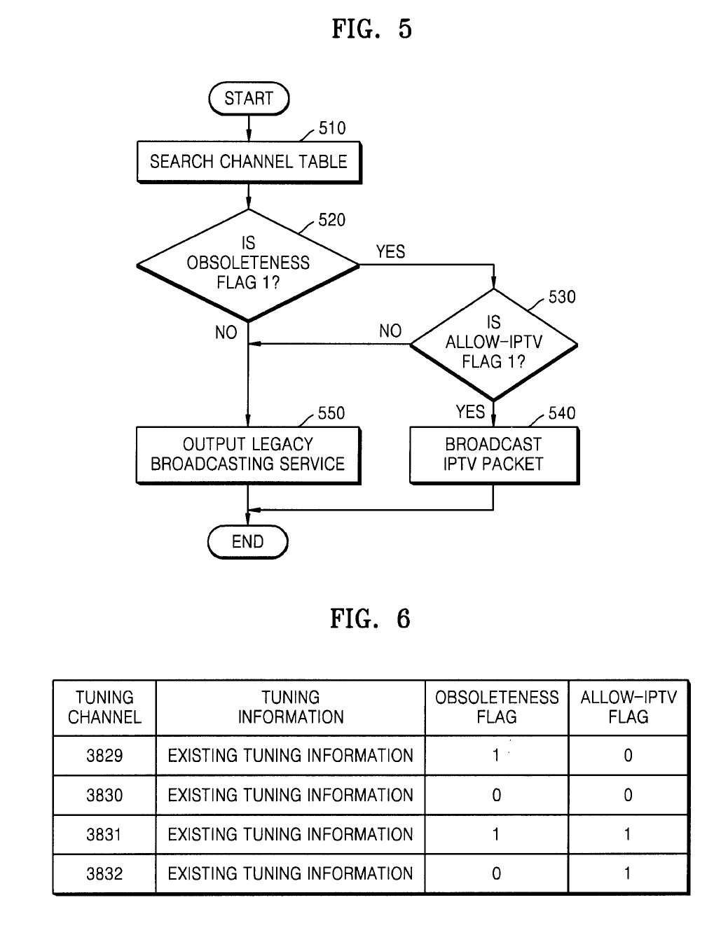

FIG. 5 is a flowchart illustrating a method of selecting a channel in a hybrid TV according to an exemplary embodiment of the present invention.

In operation 510, when a channel is selected by a user, the hybrid TV searches a channel table and extracts information on the selected channel. The information on the selected channel includes broadcasting service information (obsoleteness flag) and user setting information (allow-IPTV flag).

In operation 520, the hybrid TV determines from the broadcasting service information included in the information on the channel extracted in operation 510 whether broadcasting service providers concurrently transmit IPTV packets and legacy broadcasting signals.

In operation 530, when the broadcasting providers concurrently transmit the IPTV packets and the legacy broadcasting signals as the result of determination in operation 520 (that is, when the obsoleteness flag is 1), the hybrid TV checks the user setting information (allow-IPTV flag) on whether the user determines to watch an IPTV or legacy broadcasting program, which is previously determined by the user, when it is possible to receive the IPTV packet and the legacy broadcasting signal.

In operation 540, when the user determines to watch the IPTV broadcasting program as the result of checking in operation 530, the hybrid TV receives and broadcasts the IPTV packets.

In operation 550, when the broadcasting providers do not concurrently transmit the IPTV packets and the legacy broadcasting signals as the result of determination in operation 520 or when the user does not determine to watch the broadcasting program using the IPTV packets as the result of checking in operation 530, the hybrid TV outputs the legacy broadcasting program. In operation 530, when the user does not determine to watch the broadcasting program using the IPTV packets in operation 530, it is possible to notify the user that the user can watch the broadcasting program through the IPTV packets.

FIG. 6 illustrates a channel table used by a hybrid TV according to an exemplary embodiment of the present invention. Referring to FIGS. 5 and 6, an exemplary embodiment in which the hybrid TV of the invention selects a channel will be described.

When the channel (tuning channel) of the legacy broadcasting signal is 3289, 3830, 3831, and 3832, tuning information corresponding to tuning channels is recorded in the channel table. In addition, the channel table includes information (broadcasting service information, that is, obsoleteness flag) on whether the broadcasting providers concurrently transmit the IPTV packets and the legacy broadcasting signals in correspondence with the tuning channels and information (user setting information, that is, allow-IPTV flag) on whether the user determines to watch the IPTV broadcasting program. When the obsoleteness flag is 1, the obsoleteness flag represents that the broadcasting service providers concurrently provide the IPTV packets and the legacy broadcasting signals. When the obsoleteness flag is 0, the obsoleteness flag represents that the broadcasting service providers provide only the IPTV packets or only the legacy broadcasting signals. When the allow-IPTV flag is 1, the allow-IPTV flag represents that the user determines to watch the IPTV broadcasting program. When the allow-IPTV flag is 0, the allow-IPTV flag represents that the user does not determine to watch the IPTV broadcasting program. The allow-IPTV flag may be set by the user by using a remote control.

For example, when one or more IPTV service providers concurrently provide “A-ground wave” that is a sky wave channel and “A-IPTV” service that is an IP multicast service, the user watches one of A-IPTV and A-ground wave. When the user sets the allow-IPTV flag to 1, the IPTV service replaces the legacy broadcasting service. In the A-IPTV, data on the obsoleteness flag data and the allow-IPTV flag is added to the channel table, as compared with A-ground wave that is the sky wave channel.

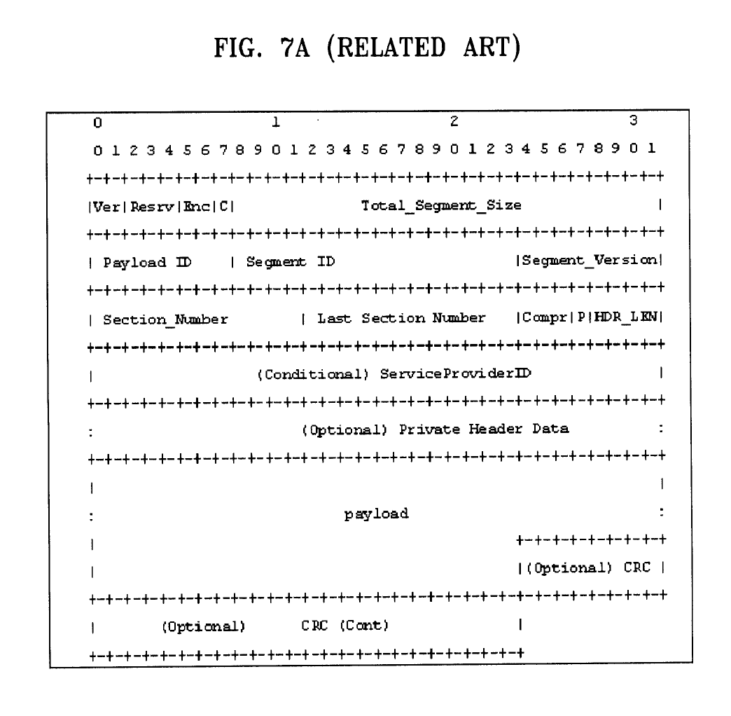

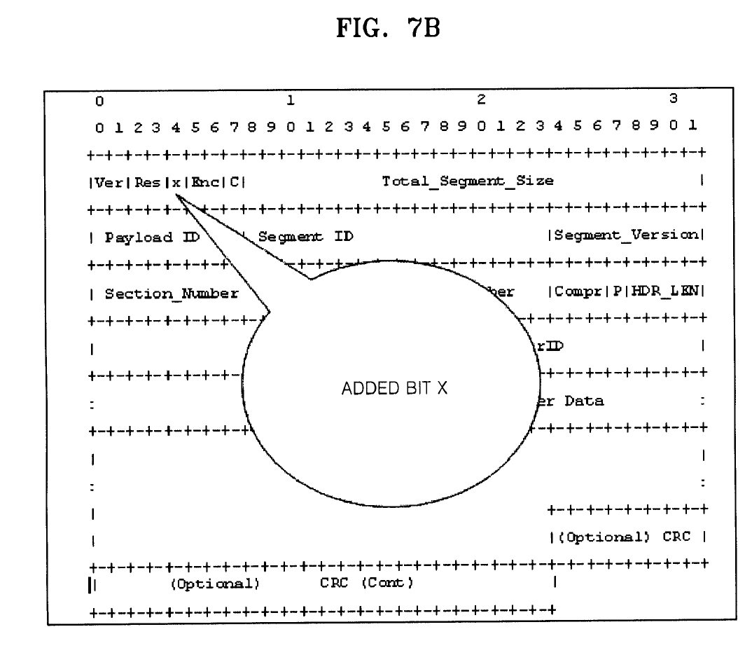

FIG. 7A illustrates a DVBSTP (SD&S multicast delivery protocol) used by a related art hybrid TV and FIG. 7B illustrates a modified DVBSTP (SD&S multicast delivery protocol) used by a hybrid TV according to an exemplary embodiment of the present invention.

Referring to FIGS. 7A and 7B, when the related art DVBSTP (SD&S multicast delivery protocol) is compared with the modified DVBSTP (SD&S multicast delivery protocol), there exist a difference in that a bit x is added. When the bit x is 1, the bit x represents that broadcasting service information is included in the DVBSTP packet. When the bit x is 0, the bit x represents that the broadcasting service information is not included in the DVBSTP packet. A provider which inserts the bit x into the DVBSTP (SD&S multicast delivery protocol) may be a broadcasting service provider or rebroadcasting service provider.

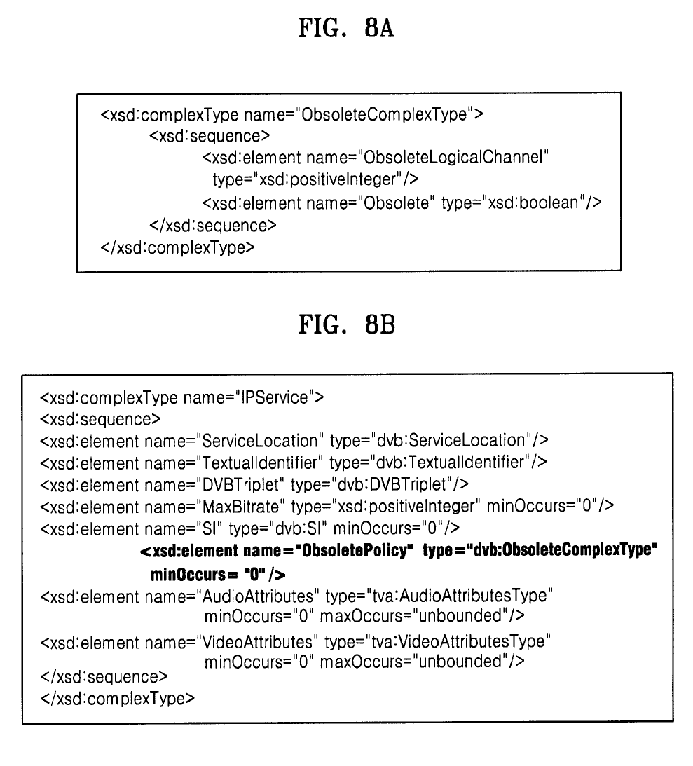

FIG. 8A illustrates an extensible markup language (XML) schema in which a modified DVBSTP (SD&S multicast delivery protocol) includes broadcasting service information. FIG. 8B illustrates a part in which an XML schema including broadcasting information is declared.

Referring to FIG. 8A, ObsoleteComplexType includes ObsoleteLogicalChannel and Obsolete. The ObsoleteLogicalChannel indicates a logical channel number which is changed from the legacy mode to the IPTV mode. The logical channel number may be a positive integer. The Obsolete has a binary value. When the binary value is true, the mode is changed from the legacy mode to the IPTV mode. When the binary value is false, the mode is not changed from the legacy mode to the IPTV mode. The Obsolete corresponds to the broadcasting service information (obsoleteness flag). Referring to FIG. 8B, ObsoleteComplexType defined in FIG. 8A is declared.

According to another aspect of the present invention the hybrid TV may store a bundle of an IPTV broadcasting service record identifier (not shown) value, the ObsoleteLogicalChannel value, and the broadcasting service information (obsoleteness flag). Bundles of the IPTV broadcasting service record identifier (not shown), the ObsoleteLogicalChannel value, and the broadcasting service information (obsoleteness flag) constitute a table (not shown). The table may be stored in a memory. The memory may be the R1 memory area.

The hybrid TV may determine which IPTV broadcasting service one or more broadcasting service providers provide as the IPTV broadcasting service in one-to-one correspondence with one legacy broadcasting service, which are substitutable for each other by searching the table (not shown). Specifically, the hybrid TV searches the table for the bundle having the same IPTV broadcasting service record identifier as the IPTV broadcasting service record identifier (not shown) of the received DVBSTP packet. When the bundle exists in the table, the ObsoleteLogicalChannel of the bundle is found. Accordingly, it can be determined which one of the legacy broadcasting service a particular IPTV broadcasting service replaces.

In another aspect of the present invention, the ObsoleteLogicalChannel value that is the same as the logical channel value of the legacy set-top box sub-system is searched for in the table. The IPTV broadcasting service record identifier is known from the found ObsoleteLogicalChannel. As a result, it is determined which IPTV broadcasting services replace a particular legacy broadcasting service. In the exemplary embodiment of the present invention, an IPTV broadcasting service identified by the IPTV broadcasting service record identifier in contents of the bundle that is initially found in the searching procedure may replace the legacy broadcasting service.

Accordingly, it is possible for the hybrid TV to selectively receive SD&S information by adding a bit for representing whether information on whether one or more broadcasting providers concurrently provide IPTV broadcasting services in one-to-one correspondence with legacy broadcasting services which are substitutable for each other is included in a DVBSTP packet to the DVBSTP packet. Thus, it is possible to reduce memory consumption of an entire system.

The exemplary embodiments of the present invention can be written as computer programs and can be implemented in general-use digital computers that execute the programs using a computer readable recording medium. In addition, a structure of data used in an exemplary embodiment of the present invention may be recorded on a computer-readable recording medium.

Examples of the computer readable recording medium include magnetic storage media (e.g., ROM, floppy disks, hard disks, etc.), and optical recording media (e.g., CD-ROMs, or DVDs).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of processing broadcasting service information, the method comprising:
determining whether broadcasting service information on whether at least one broadcasting provider concurrently provides Internet Protocol television (IPTV) broadcasting services in one-to-one correspondence with legacy broadcasting services, is included in a packet received from an IP network; and
discarding the received packet, if it is determined that the broadcasting service information is not included in the received packet.

2. The method of claim 1 further comprising:
analyzing the received packet if it is determined that the broadcasting service information is included in the received packet; and
updating a table in which the broadcasting service information is stored, if it is determined from the analysis that the broadcasting service information is changed.

3. The method of claim 1, further comprising
determining whether an hybrid TV is in a legacy mode in which a legacy broadcasting program can be watched or in an IPTV mode in which an IPTV streaming broadcasting program can be watched;
analyzing the received packet, if it is determined that the hybrid TV is in the IPTV mode; and
updating a table in which the broadcasting service information is stored, if it is determined from the analyzing that the broadcasting service information is changed.

4. The method of claim 1, wherein the received packet is a Digital Video Broadcasting Service Discovery & Selection Transport Protocol (DVBSTP) packet.

5. The method of claim 1, wherein information on the IPTV broadcasting service the at least one broadcasting service provider provides as the IPTV broadcasting service in one-to-one correspondence with one legacy broadcasting service, which are substitutable for each other is determined from Service Discovery & Selection (SD&S) information.

6. The method of claim 2, wherein the table in which the broadcasting service information is stored further comprises information on which broadcasting program between the legacy and IPTV broadcasting programs a user wants to watch.

7. The method of claim 3, wherein the table in which the broadcasting service information is stored further comprises information on which broadcasting program between the legacy and IPTV broadcasting programs a user wants to watch.

8. A hybrid Television (TV) comprising:
a control unit which determines whether broadcasting service information on whether at least one broadcasting provider concurrently provides Internet Protocol television (IPTV) broadcasting services in one-to-one correspondence with legacy broadcasting services, is included in a packet received from an IP network, and outputs a control signal for instructing the received packet to be discarded, if it is determined that broadcasting service information is not included in the received packet; and
a receiving unit which receives the control signal output from the control unit and discards the received packet.

9. The hybrid TV of claim 8, wherein if it is determined that the broadcasting service information is included in the received packet, the control unit analyzes the received packet, and if it is determined from the analysis that the broadcasting service information is changed, a table in which the broadcasting information is stored is updated.

10. The hybrid TV of claim 8, wherein the control unit determines whether the hybrid TV is in a legacy mode in which a legacy broadcasting program can be watched or in an IPTV mode in which an IPTV streaming broadcasting program can be watched, analyzes the received packet, when the hybrid TV in the IPTV mode, and updates the table in which the broadcasting service information is stored, if the broadcasting service information is changed.

11. The hybrid TV of claim 8, wherein the received packet is a Digital Video Broadcasting Service Discovery & Selection Transport Protocol (DVBSTP) packet.

12. The hybrid TV of claim 8, wherein information on which IPTV broadcasting service the at least one broadcasting service provider provides as the IPTV broadcasting services in one-to-one correspondence with the legacy broadcasting services, which are substitutable for each other, is determined from Service Discovery & Selection (SD&S) information.

13. The hybrid TV of claim 8, wherein the table in which the broadcasting service information is stored further comprises information on which broadcasting program between the legacy and IPTV broadcasting programs a user wants to watch.

14. The hybrid TV of claim 9, wherein the table in which the broadcasting service information is stored further comprises information on which broadcasting program between the legacy and IPTV broadcasting programs a user wants to watch.

15. A computer-readable recording medium having embodied thereon a computer program for executing a method of processing broadcasting service information, the method comprising:
determining whether broadcasting service information on whether at least one broadcasting provider concurrently provides Internet Protocol television (IPTV) broadcasting services in one-to-one correspondence with legacy broadcasting services, is included in a packet received from an IP network; and
discarding the received packet, if it is determined that the broadcasting service information is not included in the received packet.
